(19) United States
(12) Patent Application Publication
(10) Pub. No.: US 2013/0233406 A1
(43) Pub. Date: Sep. 12, 2013

(54) Systems And Methods For A Three Chamber Compensation Network

(71) Applicant: Andy R. Askew, Pfafftown, NC (US)

(72) Inventor: Andy R. Askew, Pfafftown, NC (US)

(73) Assignee: Fairchild Industrial Products Company

(21) Appl. No.: 13/785,761

(22) Filed: Mar. 5, 2013

Related U.S. Application Data
(60) Provisional application No. 61/607,262, filed on Mar. 6, 2012.

(51) Int. Cl. G05D 7/01

(52) U.S. Cl. CPC G05D 7/0133
USPC 137/15.19; 137/505.47

(57) ABSTRACT

Systems and methods for a three chamber compensation network for pressure regulators are disclosed. For example, one described pressure regulator includes: an inlet port; a primary chamber coupled to the inlet port by a main valve; an outlet chamber coupled to the primary chamber by one or more venturi; and a control chamber coupled to one or more of the venturi by one or more sensing holes, the control chamber comprising a movable piston configured to vary the position of the main valve.

### CROSS REFERENCE TO RELATED APPLICATIONS

This application claims priority to Provisional Patent Application No. 61/607,262 filed on Mar. 6, 2012 and entitled “Systems and Methods for a Three Chamber Flow Compensation Network,” the entirety of which is hereby incorporated by reference in this application.

### BACKGROUND

Single stage self-operating pressure reducing regulators are employed to provide pressure control in both static downstream pressure control systems and dynamic downstream pressure control systems. Such a pressure regulator may automatically position its main valve to maintain the downstream pressure. Changes in flow may influence the pressure regulator's ability to maintain the downstream pressure. Precision pressure regulators may employ some type of device to counter a drop in outlet pressure leaving the pressure regulator. In a system that does not require an external power source, this requires some kind of feedback from the system. The present disclosure provides solutions for this problem.

### SUMMARY

The present disclosure relates generally to pressure regulators and flow compensation networks. Some embodiments of the present disclosure can improve the operational accuracy and efficiency of pressure regulators and flow compensation networks.

Some embodiments of the present disclosure relate to a pressure regulator comprising: an inlet port; a primary chamber coupled to the inlet port by a main valve; an outlet chamber coupled to the primary chamber by one or more venturi; and a control chamber coupled to one or of the venturi by one or more sensing holes, the control chamber comprising a movable piston configured to vary the position of the main valve.

Some embodiments of the present disclosure relate to methods for assembling a pressure regulator comprising: coupling a spring to a screw and plate; coupling the spring to a movable piston; coupling a main valve to the movable piston; coupling a primary chamber to the main valve; coupling an outlet chamber to the primary chamber using one or more venturi; and coupling a control chamber to the primary chamber using a hole in one or more of the venturi, the control chamber configured to apply a pressure to the movable piston.

These illustrative embodiments are mentioned not to limit or define the limits of the present subject matter, but to provide an example to aid understanding thereof. Illustrative embodiments are discussed in the Detailed Description, and further description is provided there. Advantages offered by various embodiments may be further understood by examining this specification and/or by practicing one or more embodiments of the claimed subject matter.

### BRIEF DESCRIPTION OF THE DRAWINGS

FIG. 1 is a simplified diagram of a system for a three chamber compensation network according to one embodiment;

FIG. 2 is drawing representing a view of a system for a three chamber compensation network according to one embodiment;

FIG. 3A is another drawing representing a view of a system for a three chamber compensation network according to one embodiment;

FIG. 3B is another drawing representing a view of a system for a three chamber compensation network according to one embodiment;

FIG. 4 is yet another drawing representing a view of a system for a three chamber compensation network according to one embodiment;

FIG. 5 is yet another drawing representing a view of a system for a three chamber compensation network according to one embodiment; and

FIG. 6 is a chart showing a comparison of flow rate to chamber pressure in various chambers of a system for a three chamber compensation network according to one embodiment.

### DETAILED DESCRIPTION

For the purposes of this specification, unless otherwise indicated, all numbers used in the specification are to be understood as being modified in all instances by the term “about.” Accordingly, unless indicated to the contrary, the numerical parameters set forth in the following specification are approximations that can vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of this disclosure are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more, e.g. 1 to 6.1, and ending with a maximum value of 10 or less, e.g., 5.5 to 10. Additionally, any reference referred to as being “incorporated herein” is to be understood as being incorporated in its entirety.

It is further noted that, as used in this specification, the singular forms “a,” “an,” and “the” include plural referents unless expressly and unequivocally limited to one referent.

Several illustrative embodiments will now be described with respect to the accompanying drawings, which form a part hereof. While particular embodiments, in which one or more aspects of the disclosure may be implemented, are described below, other embodiments may be used and various modifications may be made without departing from the scope of the disclosure or the spirit of the appended claims.

### Illustrative Embodiment of a Three Chamber Compensation Network

An illustrative three chamber compensation network according to the present disclosure may operate to maintain constant output pressure of a media flowing through a pressure regulator. The illustrative three chamber compensation network may be able to maintain this constant pressure despite a varying input pressure or flow demands downstream of the system. In some embodiments, this media may comprise a gas, such as air, Carbon Dioxide, Nitrogen, Oxygen, Argon, Neon, a hydrocarbon such as natural gas or methane, or another gas that may be transmitted under pressure. In other embodiments, this media may comprise a liquid, such as a liquefied hydrocarbon (e.g. liquefied natural gas or liquefied methane) or another liquid that may be transmitted under pressure.

An illustrative three chamber compensation network according to the present disclosure may operate by virtue of force balance mechanical principles. In such a flow compensation network, a spring may provide force at a set-point to oppose a movable piston. When pressure is applied, the movable piston reacts and moves axially in response to pressure changes as defined by the spring rate of the spring, the effective area of the movable piston, and the pressure applied to the piston.

When the illustrative pressure regulator is in operation, the free end of the spring may be positioned to different working heights by means of a screw located on the axis of the spring. A plate fixed between the screw and the spring allows the screw to vary the tension on the spring. The force that the spring imparts to the piston may be defined by the distance the spring is compressed and the spring rate of the spring.

As the spring applies a force to the piston, the piston moves in response. Further, a main valve attached to the movable piston opens against its valve seat and allows the pressurized media which is located upstream of the main valve to travel through the now open main valve.

The media travels past the main valve into a primary chamber, which is connected to an outlet chamber via a venturi. The venturi is further connected to a control chamber via a sensing hole. In one embodiment, the sensing hole may be located at the narrowest part of the venturi, which may comprise the highest velocity/lowest pressure point in the venturi. The control chamber comprises a chamber configured to transmit a force via, the piston, to oppose the spring discussed above. Thus, as flow of the media through the main valve into the primary chamber varies, the flow of the media into the venturi varies. As the flow through the venturi varies, the velocity of the media varies as it passes through the venturi. In some embodiments, the high velocity of the media may create a low pressure at the sensing hole, which is connected to the control chamber. Thus, the pressure in the control chamber may vary as the flow through the venturi changes. Thus the force opposing the piston and spring is also varied. The piston moves in response to the pressure in the control chamber and the force applied by the spring. The movement varies the positioning of the main valve, and thereby varies the flow rate into the three chamber compensation network.

Thus, the force balance of pressure in the control chamber and the spring controls the pressure of the media into the downstream system. This enables the illustrative three chamber compensation network to output the media at a substantially constant pressure, regardless of changes to external influences on the system, such as supply pressure changes, or increases in the flow demand downstream of the three chamber compensation network.

The design discussed above employs a three chamber network with a venturi comprising a sensing hole. The sensing hole enables the low pressure formed in the narrow high velocity section of the venturi to be transferred to the control chamber. Thus, the sensing hole acts as a feedback conduit to the control chamber enabling the sensing hole to sense the flow conditioned outlet pressure.

### Simplified Diagram of a Three Chamber Compensation Network

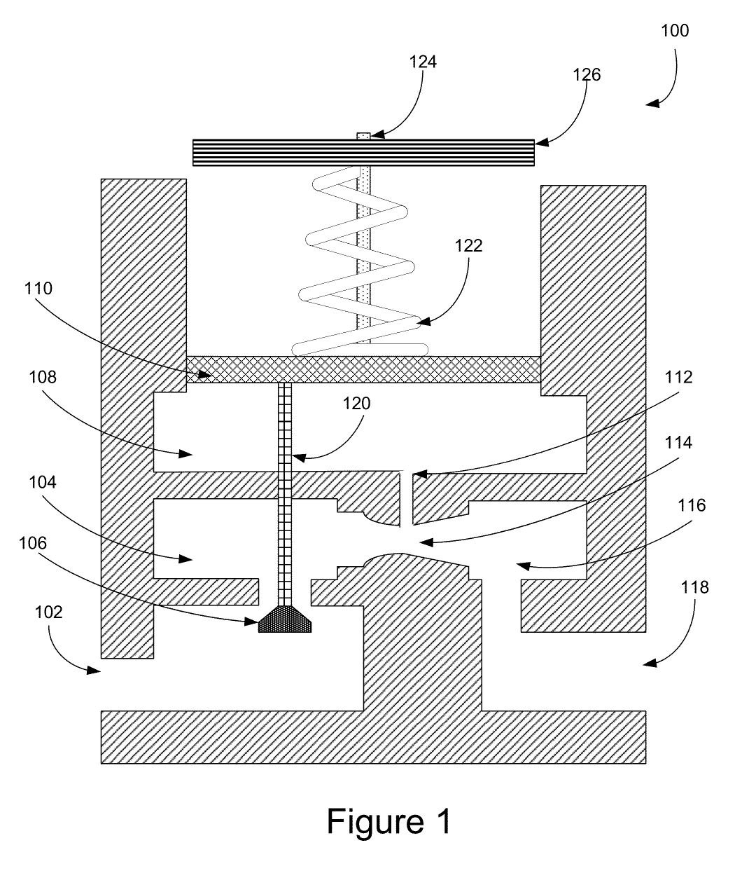

Turning now to FIG. 1, which shows system 100, a simplified diagram of one embodiment of a three chamber compensation network according to one embodiment of the present disclosure. As shown in FIG. 1, system 100 comprises an inlet port 102, through which a media, such as a gas or fluid, flows into the three chamber compensation network.

From the inlet port, the media flows through main valve 106. Main valve 106 is configured to restrict the flow of the media into a primary chamber 104. In the embodiment shown in FIG. 1, main valve 106 is coupled to a shaft 120, which when moved, will open or close main valve 106. Thus, main valve 106 is configured to be moved and thus vary the amount of the media flowing into primary chamber 104.

In the embodiment shown in FIG. 1, primary chamber 104 comprises an opening into a venturi 114. In some embodiments, venturi 114 may comprise one or more flow paths with a cross-sectional area that is, for example, a rectangular shape, a square shape, or a substantially circular shape. As the media flows through the venturi 114, the expansion and compression of the media cause the pressure inside the venturi 114 to change.

In the embodiment shown in FIG. 1, the venturi 114 comprises two outputs, first an outlet into an outlet chamber 116, which is coupled to an outlet port 118. Second, venturi 114 comprises a sensing hole 112, which allows the media to flow into a control chamber 108. In some embodiments, sensing hole 112 may be configured to sense the low pressure formed in the narrow high velocity section of the venturi 112. In some embodiments, sensing hole 112 may be positioned at the narrowest point in venturi 112. In some embodiments, sensing hole 112 acts as a feedback conduit to a control chamber to sense the flow conditioned outlet pressure.

In the embodiment shown in FIG. 1, sensing hole 112 is connected to a control chamber 108. In some embodiments, one side of control chamber 108 is substantially fixed. Further, in some embodiments, another side of control chamber 108 comprises one side of a piston 110, which is coupled via shaft 120 to main valve 106. Thus, as the pressure increases in control chamber 108, the pressure may push piston 110, and thereby move main valve 106 toward the closed position.

In the embodiment shown in FIG. 1, opposing the movement of piston 110 is a spring 122. In the embodiment shown in FIG. 1, spring 122 further comprises a plate 126 and a screw 124. In some embodiments, as screw 124 is tightened or loosened, the force that the spring 122 applies to the piston 110 may be varied.

Thus, in some embodiments, there is a force balance between the resultant force imparted to the piston 110 by the pressure in the control chamber 108 and the spring 122. Force balance principals require that, in a static system, forces are equal (F=F). Since the force developed by the pressure applied to the movable piston 110 is equal to the pressure times the area of the piston (F=P*A) and the force developed by the spring 122 is equal to the spring rate times the distance of the compression, (F=k*(x₀−x₁)), these factors must be equal (k*x₀−x₁=P*A). In this equation, the distance the piston 110 moves against the spring 122 will be equal to the pressure times the area of the piston 110 divided by the spring rate of the spring 122, (x₀−x₁=(P*A)/k). The variables in this equation are the distance (x₀−x₁) and the pressure (P). The area of the piston 110 and the spring rate of the spring 122 are fixed values. Solving for the pressure reveals that the pressure must change as the piston 110 moves against the spring 122.

In some embodiments, increasing the flow through the pressure regulator requires the spring 122 to extend to move the main valve such that a larger orifice at the main valve 106 is created. As the spring 122 extends, the force it applies to the piston 110 decreases in accordance with the spring rate and so the outlet pressure decreases according to the force balance equation (P=k*(x₀−x₁)/A), where P=Pressure, k=Spring Rate of the Spring, A=Area of the Piston, x₀=the original position of the spring, and x₁=the final position of the spring. Therefore as the flow through the pressure regulator increases, the output pressure decreases. In general, the higher the spring rate of the spring, the greater the pressure change will be to accommodate changes in flow.

Further, this force balance controls the flow of the media into the pressure regulator by moving shaft 120 to control the flow allowed by main valve 106. Therefore, in some embodiments, a three chamber compensation network will have substantially constant output pressure at outlet port 118. In some embodiments, a three chamber compensation network of the present disclosure may be able to maintain this constant pressure despite external influences. For example, in some embodiments, a three chamber compensation network according to the present disclosure may maintain constant output pressure despite a drop in input pressure or an increase in downstream flow rate.

In some embodiments of the present disclosure (not shown in FIG. 1), the system may comprise a plurality of venturi(s) 114, between the primary chamber 104 and the outlet chamber 116. Further in some embodiments, one or more of these venturi(s) 114 may comprise a sensing hole 112. For example, in some embodiments all of the venturi(s) 114 comprise a sensing hole 112. In other embodiments, less than all of the venturi(s) 114 may comprise a sensing hole 112.

In some embodiments, the number and or size of the sensing hole(s) 112 may be varied in order to tune the output pressure of the system. For example, a larger diameter sensing hole(s) 112, or a greater number of sensing hole(s) 112 may allow a greater pressure of the media in control chamber 108. This may vary the movement of piston 110, and thus vary the amount of the media allowed to flow into the system by main valve 106. Similarly, in some embodiments, a user may tune the system by turning screw 124, in order to vary the pressure applied on piston 110 by spring 122.

Further, in some embodiments, the user may vary the location of sensing hole(s) 112 on venturi(s) 114. Varying the location of the sensing holes may vary the pressure the sensing hole(s) 112 detect in venturi(s) 114, for example, because a venturi comprises varying pressures and flow rates depending on the diameter at a specific location within the venturi. Thus, the pressure in control chamber 108 may be varied by placing the sensing hole(s) 112 in varying locations within venturi(s) 114. In one embodiment, the sensing hole(s) 112 may be located at the narrowest part of the venturi(s) 114, which comprises the lowest pressure point in the venturi(s) 114. Further, in one embodiment, the sensing holes may be in the range of 0.020″-0.120″ in diameter.

Further, in some embodiments (not shown in FIG. 1) a flow compensation passage between the primary chamber 104 and the outlet chamber 116 may be utilized to modify the velocity through the venturi 114 to obtain the proper pressure correction to the control chamber 110. In some embodiments, the number and or volume of the pressure compensation passages may be used to tune the output pressure at outlet chamber 116.

### Systems for a Three Chamber Compensation Network

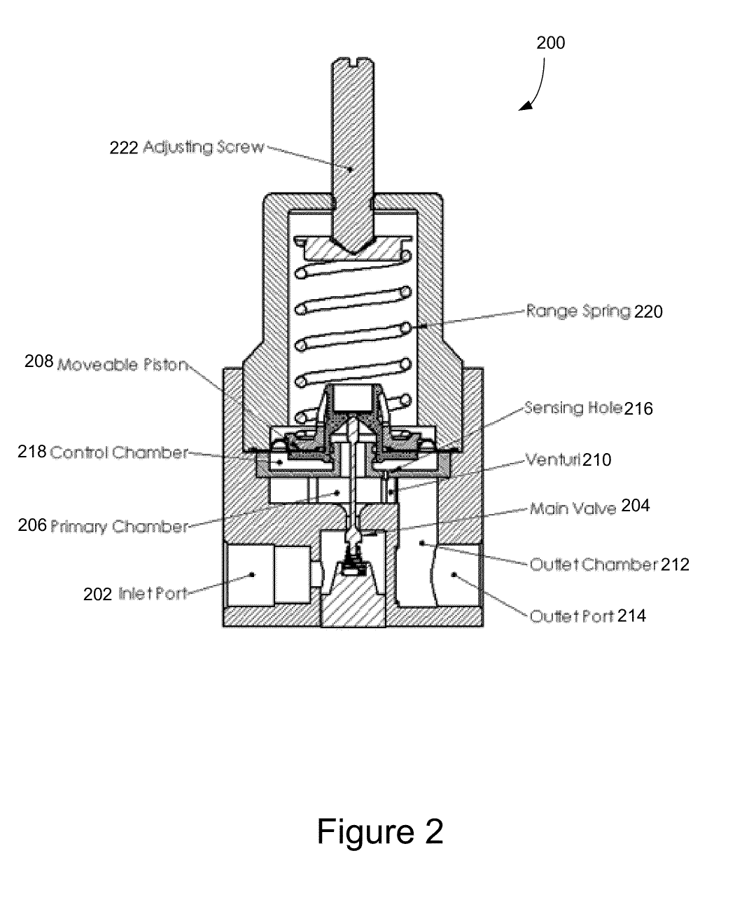

Turning now to FIG. 2, FIG. 2 is drawing representing a view of a system for a three chamber compensation network according to one embodiment. FIG. 2 shows a view of a system of the type described above with regard to FIG. 1. As shown in FIG. 2, the system 200 comprises an inlet port 202, from which a media such as a gas or fluid may flow in the system 200. From the inlet port 202, the media flows through main valve 204.

Main valve 204 is configured to restrict the flow of the media into a primary chamber 206. In the embodiment shown in FIG. 2, main valve 204 is coupled to a movable piston 208, which when moved, will open or close main valve 204. Thus, main valve 204 is configured to vary the amount of the media flowing into primary chamber 206.

In the embodiment shown in FIG. 2, primary chamber 206 comprises an opening into a venturi 210. In some embodiments, venturi 210 may comprise one or more flow paths shaped as for example a rectangular, square, or circular section venturi. As the media flows through the venturi 210, the velocity of the media causes the pressure inside the venturi 210 to change.

In the embodiment shown in FIG. 2, the venturi 210 comprises two outputs, first an outlet into an outlet chamber 212, which is coupled to an outlet port 214. Second, venturi 210 comprises a sensing hole 216, which allows the media to flow into a control chamber 218. In some embodiments, sensing hole 216 may be configured to sense the low pressure formed in the narrow high velocity section of the venturi 210. In some embodiments of the present disclosure, sensing hole 216 acts as a feedback conduit to the control chamber to sense the flow conditioned outlet pressure.

In the embodiment shown in FIG. 2, sensing hole 216 is connected to control chamber 218. In the embodiment shown in FIG. 2, one side of control chamber 218 is substantially fixed. But the other side of control chamber 218 comprises one side of movable piston 208, which is coupled to main valve 204. Thus, as the pressure increases in control chamber 218, the pressure may push movable piston 208, and thereby move main valve 204 toward the closed position.

As shown in FIG. 2, the system 200 comprises a range spring 220. The range spring 220 opposes the differential pressure across a movable piston 208 created between the outlet pressure and the atmospheric reference. In the embodiment shown in FIG. 2, spring 220 is employed to control the actuation of main valve 204. In some embodiments, a pressure set-point force is supplied by spring 220. In such an embodiment, the movable piston 208 reacts and moves axially in response to pressure changes as defined by the spring rate (or spring constant) of the range spring 220, the effective area of the movable piston 204, and the pressure applied to the movable piston 208. As the range spring 220 extends, the force it applies to the movable piston 208 decreases in accordance with the spring rate and so the outlet pressure decreases according to the force balance equation (P=k*(x₀−x₁)/A). In general, the higher the spring rate of the range spring 220 the greater the change in pressure will be.

In operation, the free end of the range spring 220 may be positioned to different working heights by loosening or tightening an adjusting screw 222 located on the axis of the spring 220. A plate fixed between the screw 222 and the range spring 220 may compress the range spring 220 such that the opposite end of the range spring 220 attached to the movable piston 208 receives a force from the spring 220 that is defined by the distance the spring 220 is compressed and the spring rate of the range spring 220.

In use, some embodiments of the system shown in FIG. 2, utilize the flow at the inlet port 202, through main valve 204, primary chamber 206, venturi 210, and sensing hole 216 to create a force balance between the control chamber 218 and the spring 222. Further, this force balance controls the flow of the media into the system by moving movable piston 208 to control the flow allowed by main valve 204. This feedback leads to a substantially constant pressure in outlet chamber 212. This constant pressure translates to a substantially constant pressure at outlet port 214. In some embodiments, this substantially constant outlet pressure may be maintained despite variances, such as an increase in downstream flow.

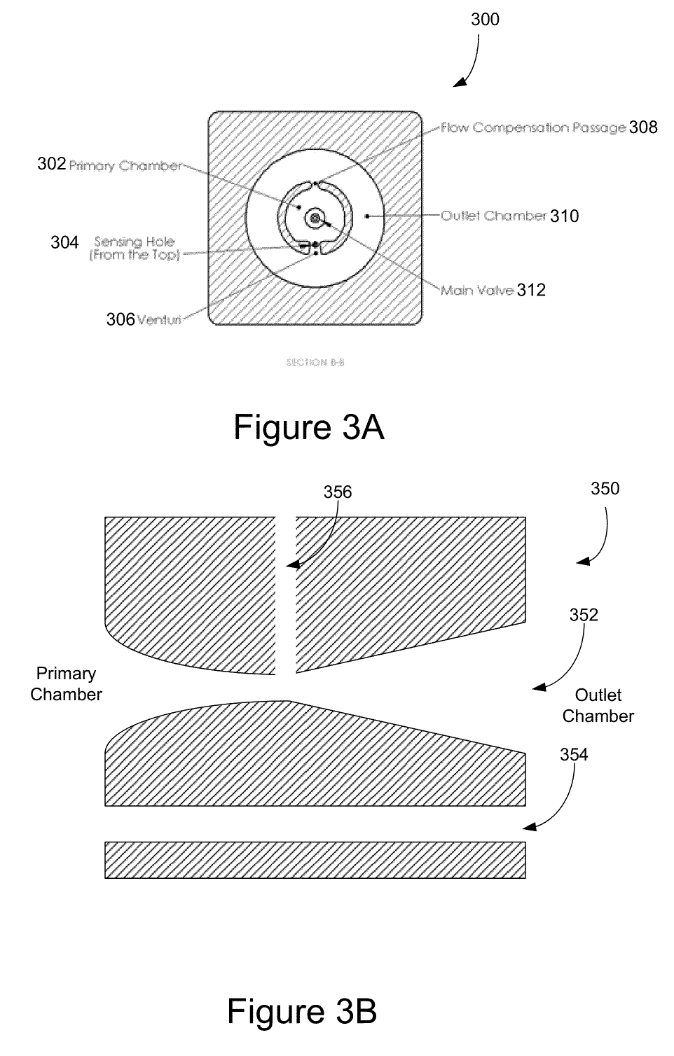

Turning now to FIG. 3A, FIG. 3A is another drawing representing a view of a system for a three chamber compensation network according to one embodiment of the present disclosure. FIG. 3A shows a system 300, which comprises a primary chamber 302, which is coupled to an outlet chamber 310 via a venturi 306. As shown in FIG. 3A, the venturi 306 comprises a sensing hole 304. As discussed above, the sensing hole 304 may be coupled to a control chamber (not shown in FIG. 3A). This control chamber may comprise a piston configured to move as the pressure varies in the control chamber, and thereby vary the position of main valve 312.

Further, as shown in FIG. 3A, the system 300 comprises a flow compensation passage 308. The flow compensation passage provides an alternative for a media (such as a gas or fluid) to flow from primary chamber 302 into outlet chamber 310, rather than flowing through venturi 306. Thus, in some embodiments, flow compensation passage 308 may be varied in size, in order to vary the flow in venturi 306, and thereby vary the pressure in sensing hole 304 and a control chamber. This may vary the extent to which a movable piston moves main valve 312. Thus, the size and shape of flow compensation passage 308 may be used by the builder of the system to vary the operation and to “tune” the output pressure at outlet chamber 310.

Turning now to FIG. 3B, FIG. 3B is another drawing representing a view of a system for a three chamber compensation network according to one embodiment. FIG. 3B comprises a diagram of system 350, which comprises a venturi 352, a flow compensation passage 354, and a sensing hole 356. As can be seen in FIG. 3B, venturi 352 and flow compensation passage 354 both comprise paths for a media to flow from a primary chamber to an outlet chamber. Further, as shown in FIG. 3B, sensing hole 356 is configured to sense pressure in venturi 352. In some embodiments, sensing hole 356 may further be connected to a control chamber (not shown in FIG. 3B). In the embodiment shown in FIG. 3B, flow compensation passage 354 may allow some of the media flowing from the primary chamber to the outlet chamber to bypass venturi 352 and sensing hole 356. In some embodiments, this may vary the pressure detected by sensing hole 356, and thereby vary the pressure in a control chamber. In some embodiments, the system may comprise multiple flow compensation passages 354. In some embodiments, the size and/or number of flow compensation passages 354 may be used to tune the output pressure of a three chamber compensation network.

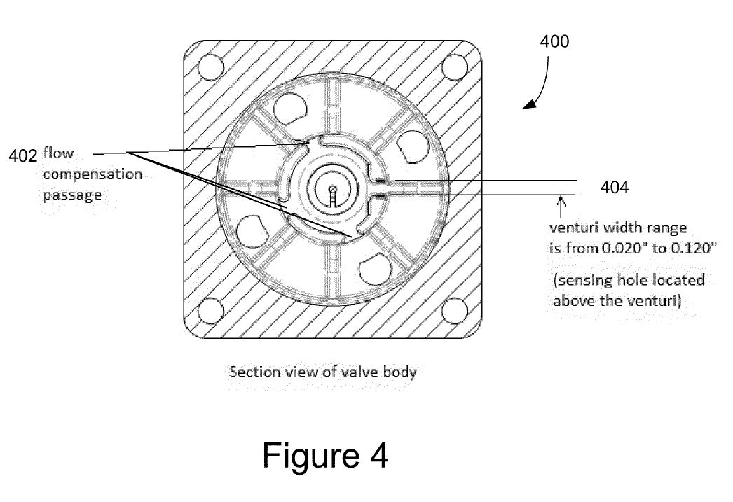

Turning now to FIG. 4, FIG. 4 is yet another drawing representing a view of a system for a three chamber compensation network according to one embodiment of the present disclosure. FIG. 4 comprises a system 400 which comprises a view of three flow compensation passages 402 and a venturi 404. In the embodiment shown in FIG. 4 the venturi comprises a sensing hole with a width in the range of 0.02″ to 0.12.″ In some embodiments (not shown in FIG. 4), the system may comprise greater or fewer flow compensation passages 402. For example, in one embodiment, a system may comprise five flow compensation passages, while in another embodiment; a system may comprise no flow compensation passages. Similarly, in some embodiments (not shown in FIG. 4), the system may comprise greater or fewer venturis. For example, in one embodiment, the system may comprise ten venturis, while in another embodiment; the system may comprise two venturis. Further, in some embodiments, not all of the venturis may comprise a sensing hole. For example, in one embodiment, only one of a plurality of venturis may comprise a sensing hole.

In some embodiments, the size and number of the venturi(s), flow compensation passage(s), and sensing hole(s) may determined based on, without limitation, one or more of the expected input pressure, the desired output pressure, the expected flow rate, the spring constant of the spring, the force applied by the spring, the size of the movable piston, the size of one or more of the primary chamber, control chamber, and output chamber, or the size of the overall system.

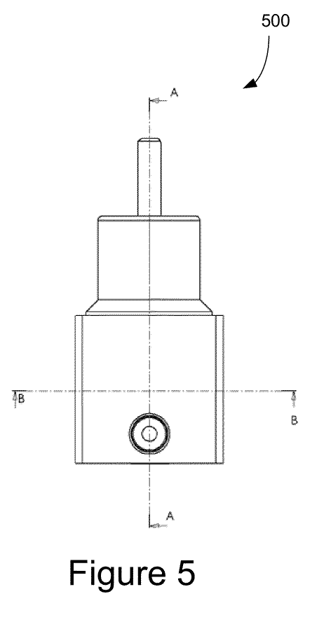

Turning now to FIG. 5, FIG. 5 is yet another drawing representing a view of a system for a three chamber compensation network according to one embodiment of the present disclosure. FIG. 5 comprises a system 500, which comprises an external view of a housing that may comprise a three chamber compensation network according to one embodiment of the present disclosure. In some embodiments of the present disclosure, the system may comprise a miniature pressure regulator configured to be used in an application that requires a small sized component capable of handling input pressures in the range of 200 psig and output pressures in the range of 150 psig.

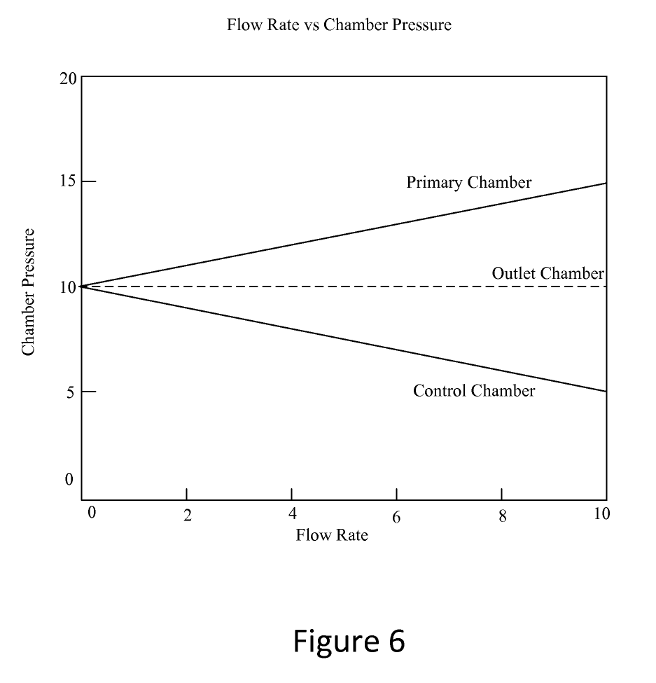

Turning now to FIG. 6, FIG. 6 is a chart showing a comparison of flow rate to chamber pressure in various chambers of a system for a three chamber compensation network according to one embodiment. As shown in FIG. 6, as the flow rate in the primary chamber increases, the pressure in the control chamber drops. This leads the movable piston to move, and thus vary the positioning of the main valve, varying the pressure allowed into the system. This balances the pressure allowed from the primary chamber through the venturi into the outlet chamber, and thereby stabilizes the outlet chamber at a substantially fixed pressure.

As discussed in further detail above, a user or designer of the system may adjust various features of the three chamber compensation network in order to regulate this pressure at various set-points. For example, in some embodiments, a user may turn an adjustable screw in order to vary the force applied to the movable piston by a spring. This may thus vary the fixed pressure in the outlet chamber. Similarly, a user may vary the number or size of flow compensation passage(s), venturi(s), or sensing hole(s) to thereby vary the pressure in the control chamber and the flow into the outlet chamber.

Some embodiments of the present disclosure advantageously provide an improved pressure regulator that utilizes a three chamber compensation network. Some embodiments of this compensation network may be simpler and cheaper to construct than other potential solutions to the pressure compensation problem. Further, the three chamber compensation network may be more stable, in some embodiments, because a sensing hole is less apt to clog than other potential systems to transmit pressure between various chambers. Furthermore, the use of a venturi provides a simple solution to reducing the measured pressure in some embodiments.

Such advantages may, in some embodiments, reduce the cost of construction as well as the cost of operation of a three chamber compensation network. This may lead to greater user adoption, as well as greater user satisfaction with the system in operation.

### General Considerations

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Having described several example configurations, various modifications, alternative constructions, and equivalents may be used without departing from the spirit of the disclosure. For example, the above elements may be components of a larger system, wherein other rules may take precedence over or otherwise modify the application of the disclosure. Also, a number of steps may be undertaken before, during, or after the above elements are considered. Accordingly, the above description does not bound the scope of the claims.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations and/or additions to the present subject matter as would be readily apparent to one of ordinary skill in the art.

That which is claimed is:

1. A pressure regulator comprising:
an inlet port;
a primary chamber coupled to the inlet port by a main valve;
an outlet chamber coupled to the primary chamber by one or more venturi(s); and
a control chamber coupled to one or more of the venturi(s) by one or more sensing hole(s), the control chamber comprising a movable piston configured to vary the position of the main valve.

2. The pressure regulator of claim 1, further comprising:
a spring configured to apply a force to the movable piston, the force opposing a pressure in the control chamber; and
a plate coupled to the spring using an adjustable screw.

3. The pressure regulator of claim 2, wherein the spring is configured to provide a pressure set-point.

4. The pressure regulator of claim 3, wherein a movement of the movable piston is defined by one or more of a spring rate of the spring, an effective area of the movable piston, and the pressure in the control chamber.

5. The pressure regulator of claim 1, further comprising one or more flow compensation passage(s) coupled to the primary chamber and the outlet chamber.

6. The pressure regulator of claim 5, wherein the one or more flow compensation passage(s) are configured to modify the flow through the one or more venturi(s).

7. The pressure regulator of claim 1, wherein the one or more venturi(s) comprise a rectangular cross-section.

8. The pressure regulator of claim 1, wherein the one or more venturi(s) comprise a substantially circular cross-section.

9. The pressure regulator of claim 1, wherein the movable piston is configured to modify the positioning of the main valve in response to a flow rate so that a pressure in the control chamber lowers as a flow in the main valve increases.

10. The pressure regulator of claim 2, wherein the spring is configured to increase a flow into the primary chamber by extending to move the main valve such that a larger input orifice is created.

11. The pressure regulator of claim 1, wherein the movable piston is configured to move axially in response to pressure changes.

12. The pressure regulator of claim 1, further comprising a dimple and wherein the hole is associated with the dimple.

13. The pressure regulator of claim 1, wherein the one or more sensing hole(s) are located at substantially the narrowest part of the one or more venturi(s).

14. The pressure regulator of claim 1, wherein the one or more sensing hole(s) act as a feedback conduit to the control chamber to sense a pressure at a location in the pressure regulator.

15. A method for assembling a pressure regulator comprising:
coupling a spring to a plate using an adjustable screw;
coupling the spring to a movable piston;
coupling a main valve to the movable piston;
coupling a primary chamber to the main valve;
coupling an outlet chamber to the primary chamber using one or more venturi(s); and
coupling a control chamber to the one or more venturi(s) using one or more sensing hole(s) in the one or more venturi(s), the control chamber configured to apply a pressure to the movable piston.

16. The method of claim 15, wherein the movable piston is configured to move axially in response to pressure changes.

17. The method of claim 15, further comprising coupling the primary chamber to the outlet chamber using one or more flow compensation passage(s).

18. The method of claim 17, wherein the one or more sensing hole(s) act as a feedback conduit to the control chamber to sense a pressure at a location in the pressure regulator

19. A pressure regulator comprising:
an inlet port;
a primary chamber coupled to the inlet port by a main valve;
an outlet chamber coupled to the primary chamber by a venturi;
one or more flow compensation passages coupled between the primary chamber and the outlet chamber, the flow compensation passages configured to modify the flow through the venturi;
a control chamber coupled to the venturi by a sensing hole in the venturi, the control chamber comprising a movable piston configured to vary the position of the main valve;
a spring configured to apply a force to the movable piston, the force opposing the force imparted to the piston by pressure in the control chamber; and
a plate coupled to the spring by an adjustable screw.
